(19) United States
(12) Patent Application Publication
(10) Pub. No.: US 2010/0076634 A1
(43) Pub. Date: Mar. 25, 2010

(54) Method for Controlling a Micro-Hybrid Electric Vehicle with an Automatic Transmission

(75) Inventor: David Richens Brigham, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/235,003

(22) Filed: Sep. 22, 2008

(51) Int. Cl. B60W 20/00

(52) U.S. Cl. 701/22; 903/930; 903/945

(57) ABSTRACT

The micro-hybrid vehicle powertrain of the invention includes a geared transmission, an engine and a starter-generator mechanically coupled to the engine to start the engine as the transmission is shifted into gear. The engine is stopped when a vehicle brake is applied.

### BACKGROUND OF THE INVENTION

1. Field of the Invention

The invention relates to an operating strategy for a micro-hybrid electric vehicle using an engine start and stop sequence to obtain optimum fuel economy.

2. Background Art

Known hybrid electric vehicle powertrains typically include separate power flow paths from an electric machine power source and from a mechanical power source, such as an internal combustion engine. Transmission gearing distributes power from the separate power sources to vehicle traction wheels. The electric machine may act as a motor or as a generator. When it acts as a generator in a power regenerative mode, mechanical inertia energy may be distributed to the generator, which converts it to electric energy to charge the battery. The electric machine acts as a generator, for example, to charge a powertrain battery during engine braking.

Since the engine is mechanically coupled to the generator, the generator may act as a motor to start the engine. When the generator and starter are combined into one machine, the combination is often referred to as an integrated starter-generator system (ISG). In a conventional vehicle powertrain, the starting and generating functions are accomplished separately by two electrical machines. This is a separated starter-generator system (SSG). The term starter-generator will be used hereinafter to designate either.

Because of the dual function of a starter-generator in known hybrid electric vehicle powertrains, as it develops regenerative power under some operating conditions and electric motive power under other operating conditions, the size, cost and weight of a starter-generator in known hybrid electric vehicle powertrains may not be suitable in certain vehicle applications.

### SUMMARY OF THE INVENTION

It is an objective of the present invention to use a so-called micro-hybrid electric vehicle architecture to reduce size, cost and weight of a hybrid electric vehicle powertrain without significantly affecting the operating characteristics of the powertrain. A micro-hybrid electric vehicle (HEV) powertrain can be defined as any HEV system with a kilowatt capacity less than approximately 3 kw at 12 volts that can stop and start the engine of the powertrain using a starter-generator. A micro-HEV using the method of the invention has less than all of the available functions of a conventional full-hybrid electric vehicle powertrain. For example, it does not provide electric vehicle launch torque nor full regenerative power. The functions that are used include an engine stop and start function while providing only a minimal engine power assist and a minimal regenerative energy recovery (e.g., <3 kw).

Because of the power limitations of a micro-HEV using the control method of the invention, the starter-generator results in a fuel economy benefit associated primarily with an engine stop and start function, which turns off the engine during engine idle when the vehicle is at rest. At that time the engine is not required to provide motive power. This function may be of more significance than a regenerative braking function for energy recovery.

If the power requirement of the hybrid electric vehicle is approximately 10 kw, for example, a fuel economy benefit (e.g., an EPA metro-highway fuel economy benefit) for the micro-hybrid powertrain of the invention due to the engine stop and start function may be as high as approximately 5%. Any braking energy recovery benefit, on the other hand, would be in addition to this fuel economy benefit, and would vary between 1% and 5%. If the regenerative braking capability of the micro-HEV would increase, the cost-benefit ratio would decrease relative to that of a conventional hybrid electric vehicle powertrain.

The micro-HEV control method of the present invention will shut off the engine and disconnect the engine for all braking events rather than using the starter-generator to collect braking energy. The engine will be disconnected from the traction wheels using the neutral gear of a power-shift, multiple-ratio automatic transmission, which is part of the vehicle powertrain. Using the design approach of the present invention, the starter-generator need only be sized for rapid and warm engine starts, rather than braking energy recovery. Due to the absence of a full regenerative mode during braking, the battery can be made smaller and less expensive than a battery for hybrid electric vehicle powertrains with more regenerative energy recovery ability.

During operation of a micro-HEV using the method of the invention, the driver may lift his or her foot off the brake pedal when the vehicle is warm and at a rest, and the starter-generator can be used to start the engine. The engine then will provide all of the driver requested power. When the vehicle is warm and moving, and the driver actuates the brake pedal, the transmission, under the control of a transmission control unit, will shift to a neutral gear. Simultaneously, the engine is stopped.

When the vehicle is moving and the driver lifts his or her foot off the brake pedal, the starter-generator will start the engine and the transmission will shift from neutral to the desired gear determined by a transmission control unit. The engine speed is synchronized to provide the driver with requested power.

When the vehicle again slows to rest and the driver presses the brake pedal, the transmission will be shifted into neutral gear and the engine will be stopped. At that time, if the vehicle is to be restarted and the engine is warm, the starter-generator will restart the engine as previously described. In the case of a cold start, a conventional starter motor can be used, and the engine may remain running until it is warm.

### BRIEF DESCRIPTION OF THE DRAWINGS

FIG. 1 is a schematic representation in block diagram form of a micro-HEV powertrain system capable of using the control method of the invention;

FIG. 2 is a schematic view of an internal combustion engine with a belt-driven, integrated starter-generator unit; and

FIG. 3 is a flowchart showing the algorithm for method steps of the stop start strategy of the present invention.

### DESCRIPTION OF AN EMBODIMENT OF THE INVENTION

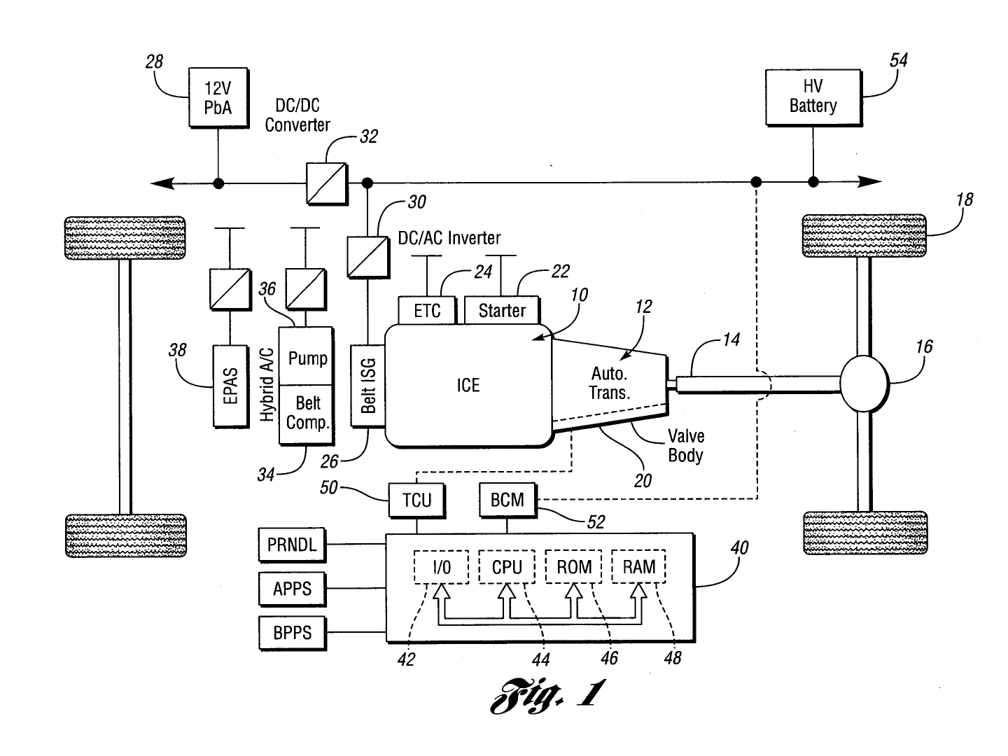

FIG. 1 schematically illustrates an internal combustion engine 10 and a multiple-ratio automatic transmission 12. Torque delivered from a crankshaft of the internal combustion engine 10 is delivered through multiple-ratio gearing of the transmission 12 to driveshaft 14 and to final drive differential-and-axle assembly 16 for traction wheels 18. The gearing for the transmission 12 establishes multiple torque ratios under the control of a valve body 20. The ratios are established by engageable and disengageable clutches and brakes in a conventional fashion. The transmission may be configured for a neutral state by disengaging a forward drive clutch in usual fashion.

A starter motor, schematically shown at 22, under the control of a low voltage battery, not shown, can be used to start engine 10 under cold start conditions. An electronic throttle control for the engine 10 is shown at 24 in block diagram form.

The engine 10 is drivably connected to a crankshaft pulley, which drives a belt-driven starter-generator unit 26 in the exemplary embodiment of the invention disclosed herein. Although a belt-drive is disclosed, a driving connection between the engine and the starter-generator 26, other types of drives could be used. For example, a flexible chain drive or a geared drive could be used, depending on design choice. The starter-generator 26 is electrically coupled to a voltage source, such as a low voltage battery 28 or a high voltage battery 54. The high voltage battery 54 may be connected to the starter-generator 26 through a DC/AC inverter 30. Hybrid vehicle accessories, such as an air conditioning compressor 34, a fuel pump 36 and a power steering pump 38, which may be electrically powered by low voltage battery 28, also are illustrated in FIG. 1. The voltage sources may be separated by DC/DC converter 32.

A powertrain microprocessor controller 40 may include an input/output signal portion 42, a central microprocessor unit 44, a random access memory section 46 and a read-only memory section 48. Controller 40 may be of conventional design for controlling a transmission control unit 50 and a battery control module 52, which is electrically coupled to the high voltage battery 54.

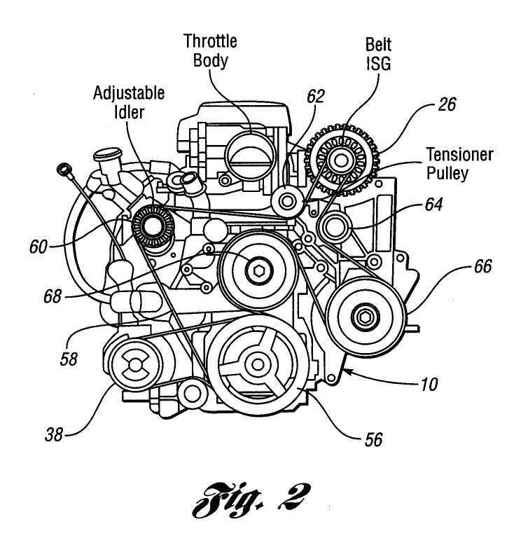

FIG. 2 is a more complete schematic illustration of engine 10. The crankshaft of the engine 10 drives a crankshaft pulley, seen at 56 in FIG. 2. A crankshaft driven belt 58 is trained over the pulley 56, over an adjustable idler 60, over tensioner pulley 62, over a drive pulley for integrated starter-generator 26, tensioner pulley 64, accessory drive pulley 66 and camshaft drive pulley 68. Power steering pump 38 has a separate mechanical connection.

In the case of a conventional hybrid electric vehicle powertrain, a large motor is provided to provide driver-requested torque when the electric motor is the sole driving power source. This electric torque is not available in the micro-hybrid electric vehicle of the present invention. Thus, the strategy of the present invention will quickly and smoothly restart the engine using only the starter-generator, while simultaneously re-engaging the engine by terminating the neutral state of the transmission.

A typical time required for the driver to move his or her foot from the brake pedal to the accelerator pedal may be about 0.2 seconds. If the engine is restarted in this time interval, the driver will not be able to feel any torque deficit. Any additional torque delay can be suitably calibrated so that the driver will not experience a driving “feel” that is significantly different from a comparable “feel” due to a turbo lag in a turbo powered engine.

In calibrating the time required for engine starts, the transmission controls should allow enough engagement time for transmission friction clutch and brake during a change from neutral to a targeted restart gear. The targeted engine restart time may be about 0.6 seconds from the engine start command to the instant when the engine delivers 80% of the requested torque. The neutral-engage portion of this target time may be about 0.4 seconds. A front, electrically-driven auxiliary pump in the transmission may be used if needed to keep the transmission clutches and brakes primed when the engine is off.

The engine control may also control a fueling strategy in order to meet emissions targets so that there will be no flow across the catalyst in an engine catalytic converter when the engine is off. Since there will be no gas flow across the catalyst, there will be no oxygen loading, and the catalyst temperature should remain high during short shut-off intervals.

The duration of the engine start delay can be calibrated. If the delay is perceptible to the driver, a more aggressive deceleration engine shut off could be selected by the driver using a driver-controlled high fuel economy switch, which could be located in the driver's compartment.

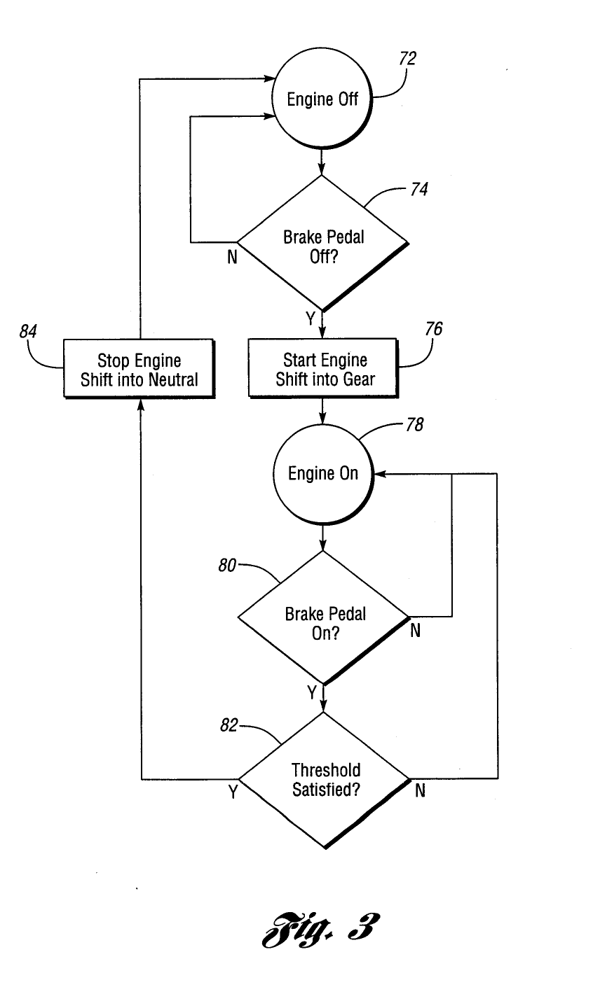

FIG. 3 shows an aggressive micro-hybrid electric vehicle stop start control strategy. It is determined whether the engine is shut off at step 72. It then is determined whether the brake pedal is on or off, as shown at 74. If the brake pedal is not off, the routine will not continue. If the brake pedal is off, the engine is started, as indicated at 76, using either a cold start feature with starter 22 or the warm engine start feature with the starter-generator 26.

After the engine is on, as determined at step 78, the routine will determine whether the brake pedal is on or off, as indicated at decision block 80. If the brake pedal is off, the routine will not continue and the engine will remain on. If the brake pedal is on, it is determined whether driver intent to stop criteria meet precalibrated threshold values, as indicated at decision block 82. One threshold value may be a speed threshold, which is calibrated. In the alternative, a time threshold can be used, either with the speed threshold or independently of the speed threshold. The time threshold would be a calibrated time period within which the brake pedal would be depressed. If the brake pedal has been depressed by the driver for a time greater than the time threshold, that would indicate a driver's intent to stop or decelerate. The control routine then will confirm that the strategy should continue and cause the engine to stop. An incidental brake pressure increase that does not indicate the driver's intent to stop or decelerate will not cause the engine to stop. Other possible thresholds that can be used to confirm the driver's intent to stop are a calibrated brake pedal travel, a calibrated brake pedal force or a calibrated brake fluid brake line pressure. These thresholds can be used independently, or more than one can be used together.

If the threshold criteria at step 82 are satisfied the routine to continue, and the engine is stopped, as shown at 84. The transmission, under the control of the transmission control unit 50, simultaneously will shift the transmission 12 into neutral, thereby disconnecting the crankshaft of the engine from the torque input elements of the automatic transmission 12.

In executing the control functions, the vehicle system control, as shown at 40 in FIG. 1, acts in response to inputs, such as the accelerator pedal position signal, a brake pedal position signal and the driver selected transmission range signal (PRNDL). The input signals are received by the input/output ports at 42 and delivered to the RAM memory section 46 where they are fetched by the CPU section 44 and used by algorithms, including the algorithm shown in flow-diagram form in FIG. 3, that are stored in ROM memory section 48. The outputs then are transferred to the transmission control unit 50 and the battery control module 52.

Although an embodiment of the invention has been disclosed, it will be apparent to persons skilled in the art that modifications may be made without departing from the scope of the invention. All such modifications and equivalents thereof are intended to be covered by the following claims.

What is claimed:

1. A method for controlling a micro-hybrid electric powertrain for a vehicle, the powertrain comprising an engine; a multiple-ratio transmission having clutches and brakes for establishing and disestablishing plural, discrete-ratio, torque flow paths from the engine to vehicle traction wheels and a transmission neutral state in which torque flow is interrupted; a starter-generator electric machine drivably coupled to the engine; a battery electrically coupled to the electric machine; and a driver-actuated vehicle wheel brake; the method comprising:
starting the engine when the vehicle wheel brake is off;
shifting the transmission to deliver torque when the engine is on;
monitoring the on-off state of the vehicle wheel brake and determining when the vehicle wheel brake is initially applied;
determining a driver's intent to stop the vehicle;
stopping the engine at the instant the vehicle wheel brake is applied when the driver intends to stop the vehicle; and
shifting the transmission to the neutral state when the engine is stopped.

2. A method for controlling a micro-hybrid electric vehicle powertrain, the powertrain comprising an engine; a multiple-ratio transmission for delivering torque from the engine to vehicle traction wheels; the transmission having a neutral state in which torque delivery is interrupted; a starter-generator mechanically coupled to the engine; a battery electrically coupled to the starter-generator; and a driver-actuated wheel brake; the method comprising:
starting the engine when the brake is off;
shifting the transmission to deliver torque when the brake is off;
monitoring vehicle speed;
determining when the wheel brake is initially applied;
determining whether the vehicle speed is below a calibrated threshold value;
stopping the engine at the instant the brake is initially applied if the vehicle speed is less than the threshold value; and
shifting the transmission to a neutral state when the engine is stopped.

3. A method for controlling a micro-hybrid electric vehicle powertrain, the powertrain comprising an engine; a multiple-ratio transmission for delivering torque from the engine to vehicle traction wheels, the transmission having a neutral state in which torque delivery is interrupted; a starter-generator mechanically coupled to the engine, a battery electrically coupled to the electric machine; and a driver-actuated wheel brake; the method comprising:
starting the engine when the brake is off;
shifting the transmission to deliver torque when the engine is on;
determining when the brake is initially applied;
determining whether the wheel brake has been applied for a calibrated threshold time;
stopping the engine if the brake has been applied for a time greater than a threshold time; and
shifting the transmission to the neutral state when the engine is stopped.

4. A method for controlling a micro-hybrid electric vehicle powertrain, the powertrain comprising an engine; a multiple-ratio transmission for delivering torque to vehicle traction wheels, the transmission having a neutral state in which torque delivery is interrupted; a starter-generator mechanically coupled to the engine; and a driver-actuated wheel brake; the method comprising:
starting the engine using the starter-generator as an engine starting torque source when the brake is off;
shifting the transmission to deliver torque when the engine is on;
determining when the wheel brake is initially applied;
stopping the engine at an instant the wheel brake is initially applied; and
shifting the transmission to the neutral state approximately simultaneously with the step of stopping the engine.

5. The method set forth in claim 3 wherein the powertrain includes an electric auxiliary starter motor, the step of starting the engine including using the electric auxiliary starter motor as an engine starting torque source when the powertrain temperature is below a predetermined temperature.

6. The method set forth in claim 4 wherein the powertrain includes an electric auxiliary starter motor, the step of starting the engine including using the electric auxiliary starter motor as an engine starting torque source when the powertrain is below a predetermined temperature.

7. The method set forth in claim 3 wherein the powertrain includes an electric auxiliary starter motor, the step of starting the engine including using the electric machine as an engine starting torque source when the powertrain temperature is above a predetermined value.

8. The method set forth in claim 1 wherein the starter-generator is coupled to the engine with a drive assembly;
the step of starting the engine comprising delivering torque from the starter-generator electric machine through a drive assembly to the engine.

9. The method set forth in claim 2 wherein the starter-generator is coupled to the engine with a drive assembly;
the step of starting the engine comprising delivering torque from the starter-generator through the drive assembly to the engine.

10. The method set forth in claim 1 wherein the step of determining a driver's intent to stop comprises determining whether the driver has applied the wheel brake with a brake force greater than a threshold value.

11. The method set forth in claim 1 wherein the step of determining a driver's intent to stop comprises determining a driver's intent to stop comprising determining whether the brake pedal travel has exceeded a threshold value.

12. The method set forth in claim 10 wherein the wheel brake force is determined by measuring a wheel brake actuating pressure.

13. The method set forth in claim 1 wherein the step of determining a driver's intent includes whether at least one of multiple criteria is satisfied, the criteria including: (i) whether the vehicle speed is less than a predetermined value; (ii) whether the brake has been applied for a period less than a calibrated threshold value; (iii) whether a brake actuating pedal travel is greater than a calibrated threshold value; and (iv) whether a brake actuating force is greater than a calibrated threshold value.

14. A micro-hybrid electric powertrain for a vehicle comprising:
an engine;
a multiple-ratio transmission having clutches and brakes for establishing and disestablishing plural, discrete-ratio torque flow paths from the engine to vehicle traction wheels and a transmission neutral state in which torque flow is interrupted;
a starter-generator drivably connected to the engine;
a battery electrically coupled to the electric machine;
a driver-actuated wheel brake; and
a controller configured to command the electric machine to start the engine using power from the battery when the brake is off, to shift the transmission to the neutral state when the engine is off, to shift the transmission to deliver torque when the engine is on and to stop the engine when the wheel brake is applied.
